(19) United States
(12) Patent Application Publication
(10) Pub. No.: US 2014/0172497 A1
(43) Pub. Date: Jun. 19, 2014

(54) APPARATUS AND METHOD FOR MANAGING RISK BASED ON PREDICTION ON SOCIAL WEB MEDIA

(71) Applicant: Electronics and Telecommunications Research Institute, Daejeon-si (KR)

(72) Inventors: Hyeon Jin KIM, Daejeon-si (KR); Chung Hee LEE, Daejeon-si (KR); HYO-JUNG OH, Daejeon-si (KR); Myung Gil JANG, Daejeon-si (KR); Yohan JO, Daejeon-si (KR); HyunKi KIM, Daejeon-si (KR); Pum Mo RYU, Daejeon-si (KR); Jeong HEO, Daejeon-si (KR); Yeo Chan YOON, Daejeon-si (KR); Miran CHOI, Daejeon-si (KR); Yoonjae CHOI, Daejeon-si (KR); Sang Kyu PARK, Daejeon-si (KR)

(21) Appl. No.: 13/868,678

(22) Filed: Apr. 23, 2013

(30) Foreign Application Priority Data
Dec. 17, 2012 (KR) 10-2012-0147067

(51) Int. Cl. G06Q 10/06; G06Q 50/00

(52) U.S. Cl. CPC G06Q 10/0635; G06Q 50/01
USPC 705/7.28

(57) ABSTRACT

An apparatus for managing risk in social web media in a prediction-based manner is provided, and includes a risk vocabulary management unit, which extracts and manages vocabulary to be managed as pertaining to risk from social web content, a risk issue prediction analysis quality extraction unit, which performs language analysis and sensitivity analysis, a risk prediction modeling unit, which models risk prediction analysis, a risk detection and notification unit, which automatically detects and notifies the risk, a risk situation monitoring unit, which monitors in real time a risk state of a risk entity when an alarm is raised with respect to the detected risk, and a risk history management unit, which receives user feedback for monitored risk information and manages a record of a terminated risk situation.

### RELATED APPLICATIONS(S)

This application claims the benefit of Korean Patent Application No. 10-2012-0147067, filed on Dec. 17, 2012, which is hereby incorporated by references as if fully set forth herein.

### FIELD OF THE INVENTION

The present invention relates to a technique of managing risk on social web media in a prediction-based manner, and more particularly to an apparatus and method for managing risk on social web media in a prediction-based manner which is suitable for predicting and identifying in advance risk (crisis) issues that are derived from or are latent in social web content (for example, SNS content, such as web content, news, blogs, and tweets) on social media to alert a user, and to continuously manage the risk issues through monitoring of a situation of developing risk.

### BACKGROUND OF THE INVENTION

As is well known, in an age where social media are utilized as tools of communications and public relations of enterprises, governments, and individuals, it frequently occurs that due to the characteristics of social media, information, which starts as a nasty rumor, complaint, or hearsay, drives the corresponding enterprises, governments, or individuals to a risk situation in a short time.

Recently, there is an increasing demand for techniques for deeply analyzing issues in various fields (for example, politics, economy, and society) or whether negative information is being spread.

In practice, among enterprises, there are specific mentions of “methods for coping with risks in social media” pertaining to cases where enterprises fall into crisis due to denunciation in social media, and it is frequent to meet with cases where enterprises are worried about taking measures against the state of risk.

However, most social media analysis techniques (for example, “Recorded Future”, “Social Metrics” of Daumsoft, “Pulse K” of Konan Technology, and the like) are mainly focused on determining which aspects of social media people are deeply interested in. Such techniques merely grasp overall trends in social media and analyze the issues, but are unsuitable for use in coping in real time with risk situations that occur.

Accordingly, there is a need for a technique which can support the prediction and recognition of a risk situation particular to an enterprise, a government, or an individual and to promptly cope with the predicted and recognized risk situation.

### SUMMARY OF THE INVENTION

In view of the above, the present invention provides a technique which can heighten the reliability of risk prediction by analyzing risk which has occurred to an enterprise, a government, or an individual, or which has the potential to occur, in social media through the application of a prediction method, notifying and monitoring a risk situation in real time, and making a system receive feedback about the risk situation and manage the history thereof.

In accordance with an aspect of the present invention, there is provided an apparatus for managing risk in a prediction-based manner on social web media, which includes: a risk vocabulary management unit extracting and managing vocabulary to be managed as pertaining to risk from social web content; a risk issue prediction analysis quality extraction unit extracting meta information related to text that is an entity for analysis from original social web content, and performing language analysis and sensitivity analysis; a risk prediction modeling unit modeling risk prediction analysis through prediction of a statistical and mechanical learning method based on extracted qualities; a risk detection and notification unit automatically detecting the risk that is recognized based on risk prediction models pre-modeled from the social web content, and automatically notifying the detected risk; a risk situation monitoring unit monitoring in real time the risk state of a risk entity when an alarm is raised with respect to the detected risk; and a risk history management unit receiving user feedback for monitored risk information, and managing a record of a terminated risk situation.

The vocabulary may include a keyword and an event to be managed as the risk.

The risk vocabulary management unit may include a manual input management block providing a user interface for inputting a risk entity keyword and an entity event to be managed; a semi-automatic recommendation block providing a user input of specific social web content to be managed as the risk, and providing a user interface for registering the event and the keyword selected from the specific social web content; and an automatic recommendation block automatically extracting the risk keyword and a risk event from similar pre-stored cases.

The risk issue prediction analysis quality extraction unit may include a social web content collection block, which collects and stores the social web content in real time; a language analysis block, which analyzes a language through natural language processing with respect to the collected social web content; a sensitivity analysis block, which analyzes the sensitivity of each word based on sensitive words appearing in an input sentence; a risk event quality extracting block, which extracts the risk event as any one quality of a noun form, a compound noun form, and a syntax form in accordance with the result of language analysis; a frequency quality extracting block, which extracts information on how many times per unit time the risk entity keyword and the entity event appear on the social web content; a sensitivity quality extracting block, which extracts sensitivity analysis information in a sentence with respect to the risk entity keyword and extracts the extent to which a change of the corresponding sensitivity includes a negative sensitivity as a sensitivity quality; a network propagation quality extracting block, which extracts a change of a propagation aspect of a network in a unit of time as a risk issue quality; and a lifecycle quality extracting block, which extracts aspects of the risk keyword and the event appearing in the document as a lifecycle quality.

The natural language processing may include preprocessing of the social web content, morphological analysis, named entity recognition, syntax analysis, and relation extraction.

The natural language processing may be applied differently depending on the kind and the stage of predicted quality for the social web content.

The sensitivity analysis block may extract and subdivide degrees of sensitivity of respective words as numerical information.

The sensitivity analysis block may classify the sensitivity of each word into any one of “positive”, “negative”, “neutral”, and “quality”.

The frequency quality extracting block may extract whether a relatively high frequency is extracted in a relatively short time, whether continuity is maintained, or whether an abnormal frequency that is different from a normal frequency is extracted, through modeling of frequencies with the passage of time, as a frequency quality.

The network propagation quality extracting block may extract whether a form of the network propagation aspect is uniformly distributed to other user groups and whether a propagation speed is high as a network propagation quality.

The lifecycle quality extracting block may classify and define frequencies by time periods into lifecycle forms and types of “new”, “dead”, and “recycled” to utilize the frequencies as modeling qualities for indicating whether the aspect is a normal phenomenon or a phenomenon that can be recognized as a risk state.

The risk prediction modeling unit may use any one of logistic regression, linear regression, and an SVM method as the statistical and mechanical method.

The risk situation monitoring unit may include a frequency monitoring block, which monitors current real-time frequencies and frequencies in past social web content with respect to the risk entity; a sensitivity spectrum monitoring block, which provides sensitivity information about the risk entity as a spectrum with the passage of time; a network distribution monitoring block, which defines and provides a network propagation aspect in a graphic form or in a classification type; a media diffusion monitoring block, which monitors a diffusion aspect of the social web content with respect to the risk entity by media; a similar case search block, which searches to determine whether there is a history in which a similar risk event has occurred in the risk entity and a past case; and a risk feedback block, which transfers feedback for a notification of the detected risk.

The classification type may be any one of a distribution type, a compact type, and a diffusion type.

The risk history management unit may include a risk state feedback block, which transfers feedback to a system with respect to a risk alarm; a feedback-based risk model learning block, which re-learns a risk model in accordance with information reflected in the risk state feedback; a similar case search block, which searches to determine whether there is a history of a similar risk event having occurred in the risk entity and in past cases; and a risk type analysis block, which analyzes a type of the risk and provides statistical information about the risk management entity.

The risk state feedback block may transfer a risk release feedback to the system for reflection of performance improvement in the case where a risk state is not present.

The similar case search block may search for a risk event occurring in the past in the same risk entity or a similar risk event occurring in the past in a risk entity of the same classification.

The risk type analysis block may provide any one of a risk event type according to the risk entity, a seasonal risk type or a repeated risk type with the passage of time, and a one-time risk type or an ongoing risk type according to the aspect of diffusion.

In accordance with another aspect of the present invention, there is provided a method for managing a risk in a prediction-based manner in social web media, which includes: extracting and managing vocabulary to be managed as pertaining to risk from social web content; extracting meta information related to text that is an entity for analysis from original social web content, and performing language analysis and sensitivity analysis; modeling risk prediction analysis through prediction of a statistical and mechanical learning method based on extracted qualities; automatically detecting and notifying the risk that is recognized based on risk prediction models pre-modeled from the social web content; monitoring in real time a risk state of a risk entity when an alarm is raised with respect to the detected risk; and recording a related risk termination situation in a risk history DB when the situation of the detected risk is terminated.

The modeling may use any one of logistic regression, linear regression, and an SVM method as the statistical and mechanical method.

In accordance with the present invention, by finding in advance risk issues which are derived from or are latent in social web content and predicting future proceedings through monitoring of the situation of developing risk, enterprises, governments, or individuals can cope with and manage risk (crisis) situations that may arise in social media at an appropriate time. Thus the present invention has the following effects.

First, since the risk issue related to the risk entity is automatically detected and the user is notified in advance about the risk that is classified by stages, schemes for coping with the risk that may occur in advance can be provided.

Second, since the prediction model is presented through the extraction of various language/network qualities from past data, rather than reporting the situation through determination using only the temporary phenomenon of the data, accurate information about a risk state can be provided at an earlier time.

Third, since the schemes for optimizing the risk modeling for each user are presented through feedback between the system and the user, rather than reflecting the one-sided result of the system, continuous improvement in performance of the system can be realized.

### BRIEF DESCRIPTION OF THE DRAWINGS

The objects and qualities of the present invention will become apparent from the following description of embodiments given in conjunction with the accompanying drawings, in which:

FIG. 1 is a block diagram of an apparatus for managing risk in a prediction-based manner in social web media in accordance with the present invention;

FIG. 2 is a detailed block diagram of a risk vocabulary management unit illustrated in FIG. 1;

FIG. 3 is a detailed block diagram of a risk issue prediction analysis quality extraction unit illustrated in FIG. 1;

FIG. 4 is a conceptual view explaining an exemplary scenario 1 for risk detection and notification in accordance with the present invention;

FIG. 5 is a conceptual view explaining an exemplary scenario 2 for risk detection and notification in accordance with the present invention;

FIG. 6 is a conceptual view explaining an exemplary scenario 1 for monitoring a risk situation in accordance with the present invention;

FIG. 7 is a conceptual view explaining an exemplary scenario 2 for monitoring a risk situation in accordance with the present invention;

FIG. 8 is a detailed block diagram of the risk situation monitoring unit illustrated in FIG. 1;

FIG. 9 is a conceptual view explaining an exemplary scenario 1 for monitoring detailed risk information in accordance with the present invention;

FIG. 10 is a conceptual view explaining an exemplary scenario 2 for monitoring detailed risk information in accordance with the present invention;

FIG. 11 is a conceptual view explaining an exemplary scenario 3 for monitoring detailed risk information in accordance with the present invention; and

FIG. 12 is a detailed block diagram of the risk history management unit illustrated in FIG. 1.

### DETAILED DESCRIPTION OF THE EMBODIMENTS

The aspects and qualities of the present invention and methods for achieving the aspects and qualities will be apparent by referring to the embodiments to be described in detail with reference to the accompanying drawings. Here, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims.

Further, in the following description of the present invention, a detailed description of known functions and configurations incorporated herein will be omitted when it may make the subject matter of the present invention rather unclear. Also, the following terms are defined in consideration of the functions of the present invention, and may be differently defined according to the intention of an operator or custom. Therefore, the terms should be defined based on the contents of the specification.

Hereinafter, preferred embodiments of the present invention will be described in detail with reference to the accompanying drawings.

First, risk, risk entity, and risk event, which are terms used in the present invention, may be defined as follows.

Risk

An issue that is a threat to a client (user) or latently includes a danger, among various issues arising in social web content (for example, SNS document, such as news, blogs, and tweets), is defined as a risk.

Risk Entity

All that should manage risks may be risk entities, and may mainly be enterprises, brands, products, people (for example, a specific celebrity, a representative of an institution, a performer, or the like), a policy, or an institution (including a government agency).

Risk Event

Dangerous things selected as risk entities may be defined as risk events, and with respect to the enterprise, the product, the person, and the policy, for example, the following items may be risk events to be managed.

Events caused by technical reasons: Inferiority/trouble, recall/withdrawal, information leakage, bacterial detection, accidents, and the like

Events caused by internal/external hostile influences: boycotts, nasty rumors, and the like

Events related to climate, natural factors, or the environment: typhoons, droughts, oil leaks, pollution, and the like

Events caused by illegal/legal action: litigation, illegal actions, violations/exposures, and the like

Events caused by irregularities and corruption: various kinds of irregularities, such as acceptance of bribes, military service avoidance, and the like

Other events: drugs, scandals, and the like

### Embodiment 1

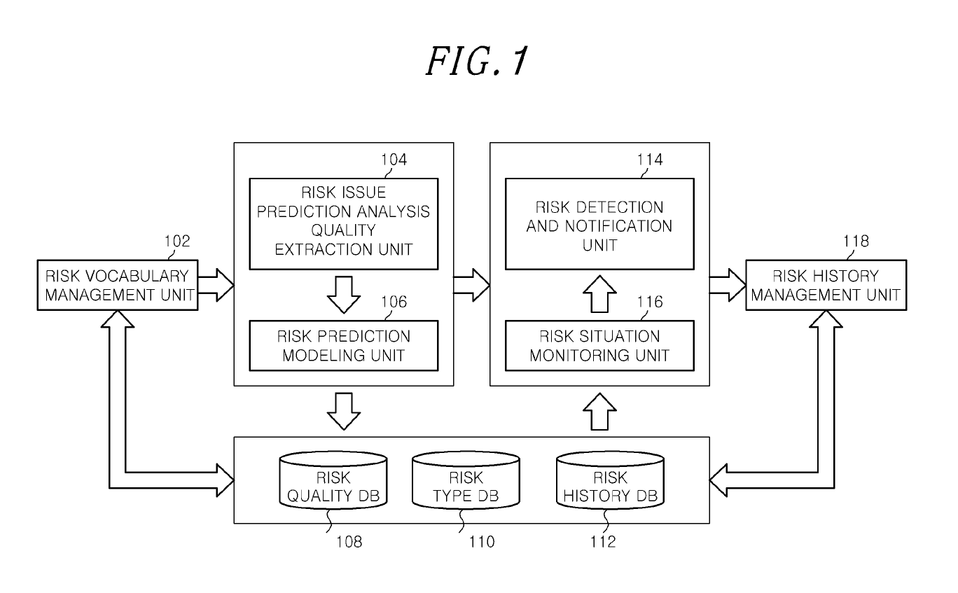

FIG. 1 is a block diagram of an apparatus for managing risk in a prediction-based manner in social web media in accordance with the present invention. An apparatus for managing risk in a prediction-based manner according to the present invention includes a risk vocabulary management unit 102, a risk issue prediction analysis quality extraction unit 104, a risk prediction modeling unit 106, a risk prediction quality DB 108, a risk type DB 110, a risk history DB 112, a risk detection and notification unit 114, a risk situation monitoring unit 116, and a risk history management unit 118.

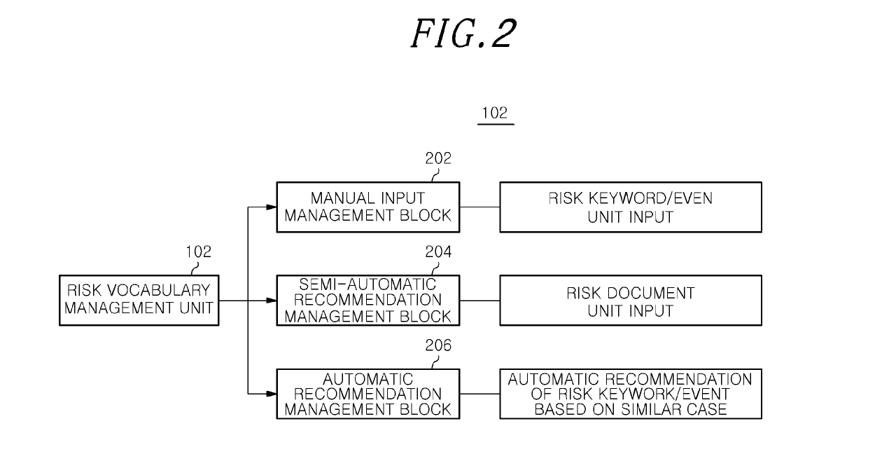

Referring to FIG. 1, the risk vocabulary management unit 102 may extract vocabulary (entity keyword and entity event) to be managed as pertaining to a risk from social web content, that is, may extract and manage the vocabulary, such as a keyword or an event, to be managed as pertaining to risk from the social web content. For this, the risk vocabulary management unit 102 may include the configuration illustrated in FIG. 2.

FIG. 2 is a detailed block diagram of the risk vocabulary management unit illustrated in FIG. 1. The risk vocabulary management unit 102 may include a manual input management block 202, a semi-automatic recommendation management block 204, and an automatic recommendation management block 206.

Referring to FIG. 2, the manual input management block 202 may provide a user interface for inputting a risk entity keyword and an entity event to be managed, and through this, the system can perform management functions, such as risk detection and monitoring around a management entity keyword input by a user and the entity event.

Next, the semi-automatic recommendation block 204 may provide a user input of specific social web content to be managed as the risk, automatically extract the risk management entity and the event keywords from a document of the corresponding social web content to show (display) them as candidates, register the management entity and the risk events selected by a user from the specific social web content, and provide a user interface for this.

Further, the automatic recommendation block 206 may automatically extract the risk keyword and the risk event from similar cases which are pre-constructed in the system and stored in the risk type DB. That is, the automatic recommendation block 206 may search for cases that are similar to the risk entity, and automatically recommend similar risk events. For this, risk events for respective entities are extracted from the pre-constructed risk cases, and are stored in the risk type DB 110.

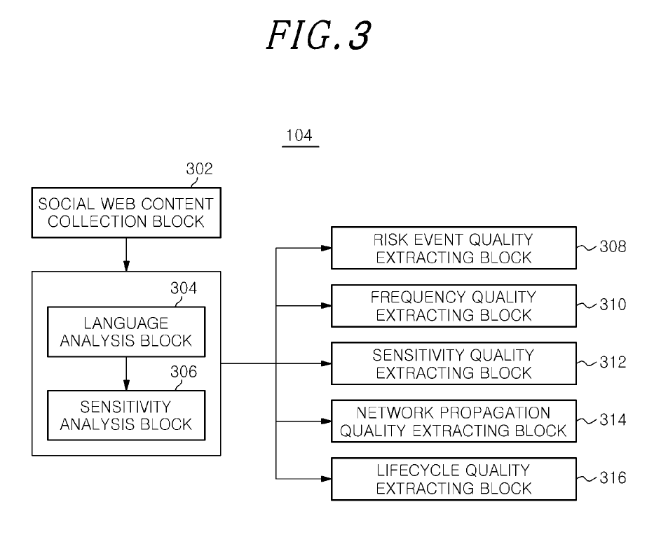

Referring again to FIG. 1, the risk issue prediction analysis quality extraction unit 104 may extract meta information related to text that is an entity for analysis from the original social web content, and perform language analysis and sensitivity analysis. For this, the risk issue prediction analysis quality extraction unit 104 may include the configuration illustrated in FIG. 3.

FIG. 3 is a detailed block diagram of the risk issue prediction analysis quality extraction unit illustrated in FIG. 1. A risk issue prediction analysis quality extraction unit 104 may include a social web content collection block 302, a language analysis block 304, a sensitivity analysis block 306, a risk event quality extracting block 308, a frequency quality extracting block 310, a sensitivity quality extracting block 312, a network propagation quality extracting block 314, and a write cycle quality extracting block 316.

Referring to FIG. 3, the social web content collection block 302 may collect in real time social web content, that is, for example, SNS documents, such as web documents, news, blogs, and tweets, and store the collected content in the risk prediction quality DB 108.

Next, the language analysis block 304 may analyze the language through natural language processing with respect to the social web content collected and stored in the risk prediction quality DB 108, that is, may perform the general process of natural language processing technology, such as preprocessing of the social web content (for example, performing of processes of filtering to remove unnecessary data and sentence parsing), morphological analysis, named entity recognition, syntax analysis, and relation extraction. In this case, applied language processing stages may differ depending on the kind and the stage of prediction qualities with respect to the social web content.

Further, the sensitivity analysis block 306 may analyze the sensitivity of each word based on sensitive words appearing in an input sentence. That is, the sensitivity analysis block 306 may briefly analyze positive and negative sensitivities based on the sensitive words (for example, “bad”, “good”, “glad”, “angry”, “get irritated”, “refuse”, “approve”, and the like) appearing in the input sentence.

Here, the sensitivity information may be roughly divided into “positive”, “negative”, and “neutral”. Further, the sensitivity may be extracted as numerical information through extraction of the degree of sensitivity in accordance with a sensitivity analyzing system, for example, the stages may be further subdivided (“very positive”, “positive”, “neutral”, “negative”, and “very negative”), or the sensitivities of “positive” and “negative” may be further subdivided through sub-classification of the sensitivities and extracted (classified) into qualities (for example, “anger”, “disappointment”, “surprise”, “passion”, “doubt”, “suspicion”, and the like).

Further, the risk event quality extraction block 308 may extract the risk event as various qualities, such as a noun form (for example, “irrationality”, “suspicion”, and the like), a compound noun form (for example, “boycott”, “acceptance of a bribe”, and the like), and a syntax form (for example, “accused of patent infringement”) in accordance with the result of language analysis by the language analysis block 304.

Next, the frequency quality extracting block 310 may extract information on how many times per unit time the risk entity keyword and the entity event appear in the social web content. That is, the frequency quality extracting block 310 may extract whether extraction occurs at a relatively high frequency in a relatively short time, whether continuity is maintained, or whether an abnormal frequency that is different from a normal frequency is extracted, through modeling of frequencies over the passage of time, as a frequency quality.

Further, the sensitivity quality extracting block 312 may extract sensitivity analysis information in a sentence with respect to the risk entity keyword, and may extract and use the extent to which a change in the corresponding sensitivity includes a negative sensitivity and the degree of sensitivity classification (for example, subdivided sensitivity classification of “negative”, such as “anger”, “disappointment”, “suspicion”, and the like) that frequently occurs on the risk event as qualities.

The network propagation quality extracting block 314 may extract a change of a propagation aspect of a network in a unit of time as a risk issue quality. For example, in the case of SNS content such as tweets, the network propagation quality extracting block 314 may extract the propagation aspect, such as retweets or the like, and use the propagation aspect as a risk issue quality through the change of the propagation aspect over the unit of time. For example, the network propagation quality extracting block 314 may extract and use whether the form of the network propagation aspect is uniformly distributed to various user groups versus whether the form is propagated only to specific user groups, and whether a propagation speed is high as a network propagation quality. Last, the lifecycle quality extracting block 316 may extract aspects of the risk keyword (entity word) and the event appearing in the document as a lifecycle quality. That is, the lifecycle quality extracting block 316 may extract the aspect that appears in the risk keyword and the event, and classify and define frequencies by time periods into lifecycle forms and types of “new”, “dead”, and “recycled” to utilize the frequencies as modeling qualities for indicating whether the aspect is a normal phenomenon or a phenomenon that can be recognized as a risk state. The lifecycle forms may be defined as follows.

New: initial appearance in a period

Growing: continuously constant increase after initial appearance

Steady: maintenance of continuously constant level without showing a special increase/decrease curve

Declining: approaching a declining period in a lifecycle stage

Dead: complete disappearance after revelation through a lifecycle

Recycled: repeated after having been dead

Seasonally recycled: repeated as seasonal/temporal factor

Recycled as outlier: recycled without special factor

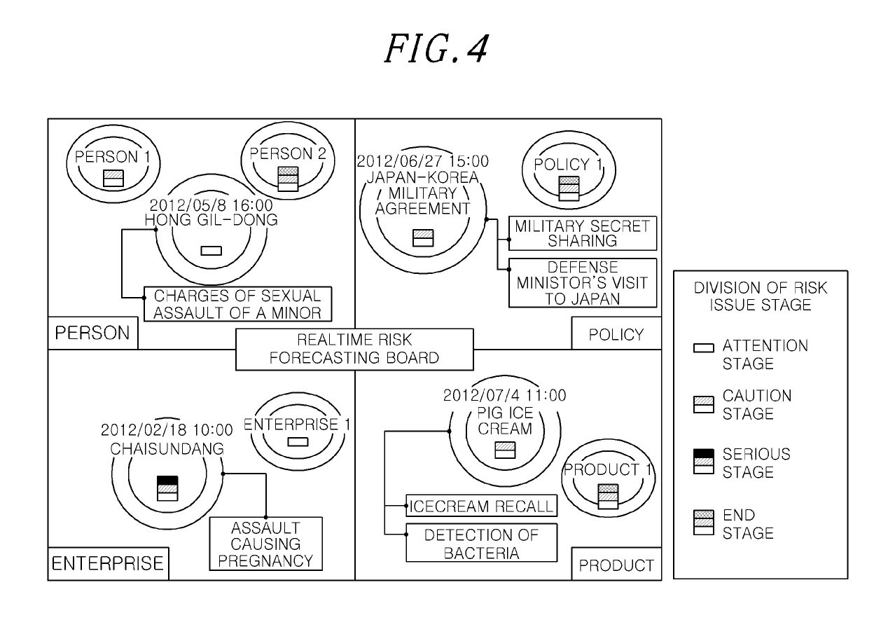

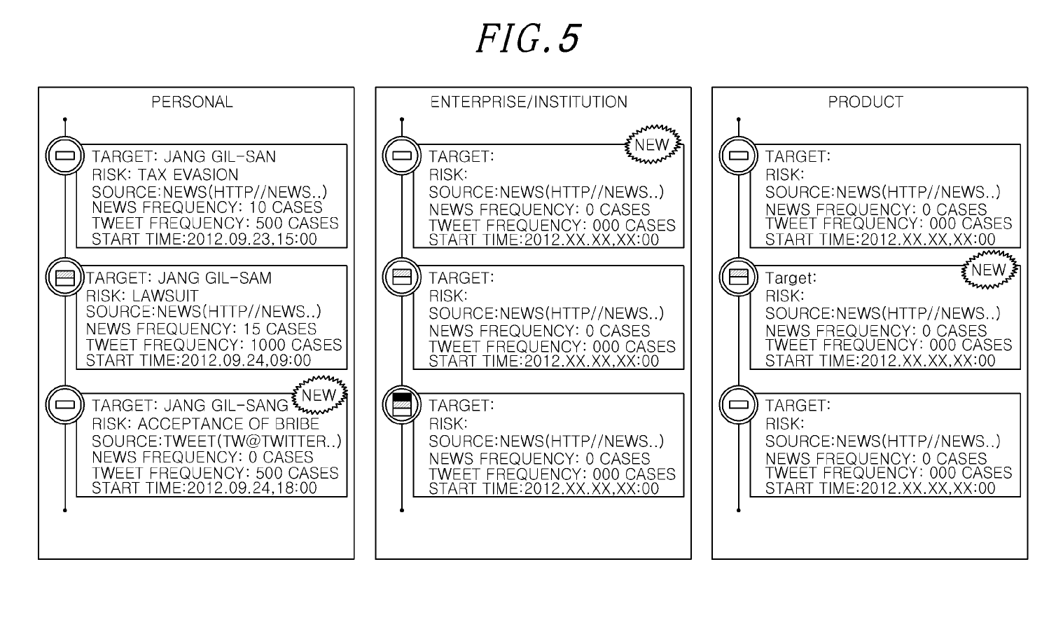

FIG. 4 is a conceptual view explaining an exemplary scenario 1 for risk detection and notification in accordance with the present invention, and FIG. 5 is a conceptual view explaining an exemplary scenario 2 for risk detection and notification in accordance with the present invention.

Referring to FIG. 4, the risk entities are classified by domain (for example, a person, a policy, an enterprise, a product, and the like), and the entities which are detected in real time as risks by domain are shown (displayed) on a screen, risk states (for example, attention stage, caution stage, serious stage, and end stage) in the present time period are shown with respect to the respective risk entities (for example, Japan-Korea military agreement (policy example), Pig Ice cream (product example), and the like), and the events that are risk entities (for example, detection of bacteria, charges of sexual assault, and the like) are displayed on the screen, so that a user can monitor the risk states by time period on a signal screen.

Referring to FIG. 5, risks which are detected for the respective domains (for example, a person, enterprise/institution, product, and the like) in accordance with time flow or risk stages may be arranged in a row, and part of the detailed contents of the respective risks may be shown in a summary form.

Referring again to FIG. 1, the risk prediction modeling unit 106 may perform modeling of risk prediction analysis through prediction of a statistical and mechanical learning method based on the extracted qualities. Here, as the statistical and mechanical learning method, any one of logistic regression, linear regression, and an SVM method may be used.

Further, the risk detection and notification unit 114 may automatically detect the risk that is recognized based on risk prediction models pre-modeled from the social web content, and automatically notify the detected risk.

That is, in the case of recognizing the risk based on the risk prediction models that are pre-modeled from the social web content input in real time, the risk may be automatically detected, and the risk stage (for example, attention, caution, or serious stage) may be recognized and displayed on the screen. As an example, as illustrated in FIGS. 4 and 5, if risks are detected in accordance with the domains (for example, a policy, a person, an enterprise, a product, and the like), and the corresponding risk is detected from the risk entity, such as an enterprise, an institution, a brand, a person, or the like, of which the risk keyword and the event have been registered, the risk detection and notification unit 114 may provide a function of automatically providing an alarm (for example, additional media, such as e-mail, SMS/MMS, and SNS, may be utilized) to a user.

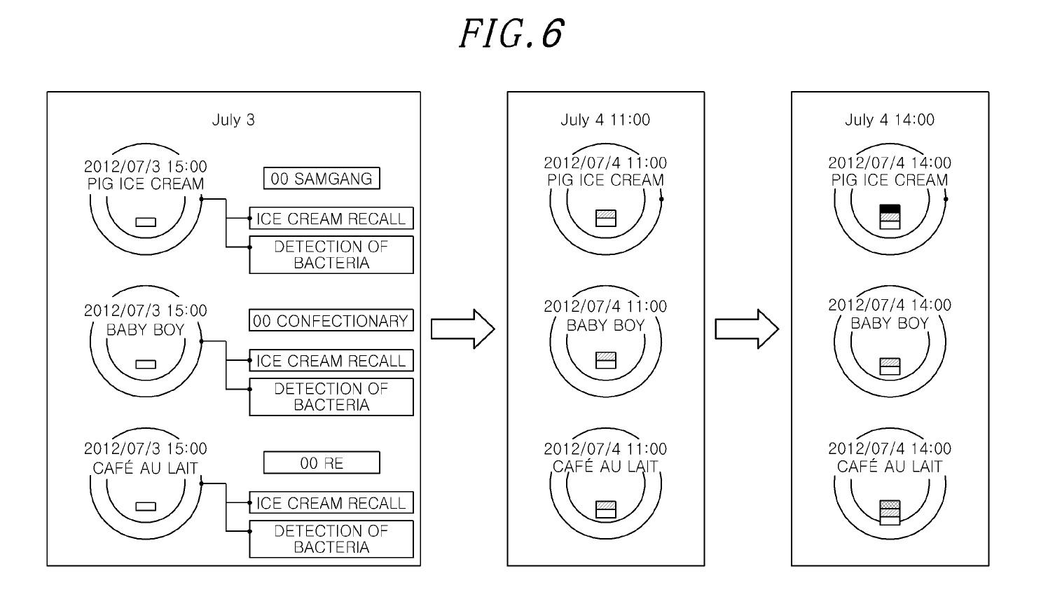

Next, the risk situation monitoring unit 116 may monitor in real time the risk state of the risk entity when the alarm is raised with respect to the risk detected through the risk detection and notification unit 114. This will be described in detail with reference to FIGS. 6 to 11.

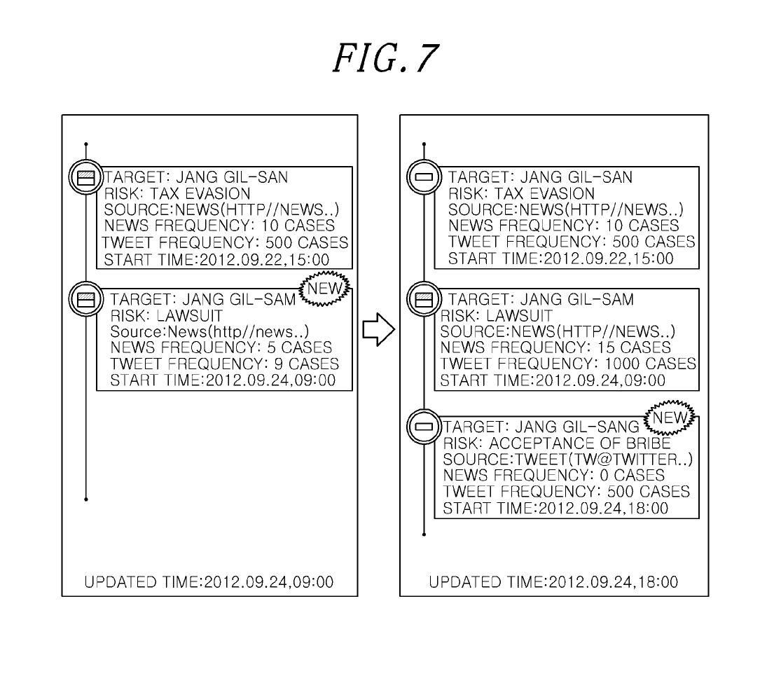

FIG. 6 is a conceptual view explaining an exemplary scenario 1 for monitoring a risk situation in accordance with the present invention, and FIG. 7 is a conceptual view explaining an exemplary scenario 2 for monitoring a risk situation in accordance with the present invention.

Referring to FIG. 6, a first scene shows an example in the case where a risk alarm is generated in a specific time period. In this case, a specific risk entity product is shown on the screen, and the current risk state is indicated. The risk state may be changed depending on the result of risk analysis with the passage of time, and continuous monitoring of the change states of the respective risk stages over time may be supported.

In the last stage, for example, in the case of “Pig Ice cream”, it can be known that the risk stages have proceeded (for example, attention→caution→serious) as the result of risk prediction, and in the case of “Café Au Lait”, an end state is displayed in the same time period. If there is a change of the risk stage with the passage of time in this manner, it is displayed on the screen in real time, and through this, the user can recognize the change of the state.

Referring to FIG. 7, the scenario shows that the changes of the risk situation and the amount of collected data are monitored with the passage of time.

Referring again to FIG. 1, the risk situation monitoring unit 116 provides additional information on the corresponding risk entity on the screen if the user clicks a specific risk entity, searches for the specific risk entity, or designates a specific entity as a risk monitoring entity. On the screen, the past history of the specific risk entity is shown for respective time periods, and the risk event that is currently notified as a risk is also displayed on the screen.

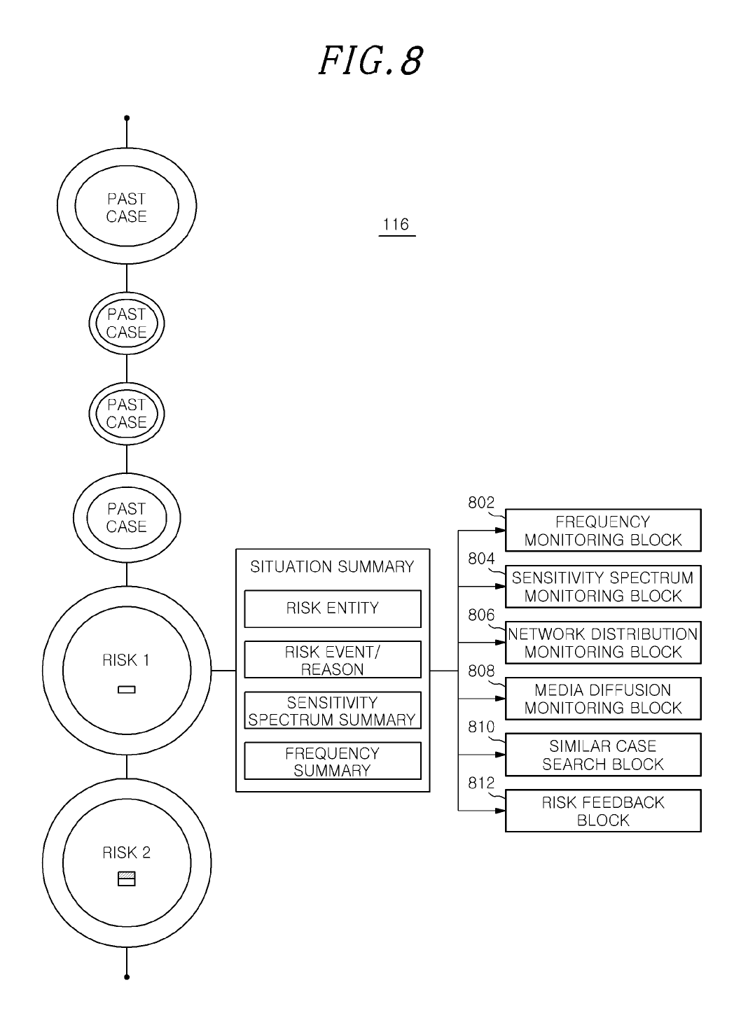

Further, if the user selects the corresponding risk, simple information is first provided through a situation summary, and this situation summary shows event information describing the entity of the corresponding risk and the reason why the entity has been selected as a risk, a simple sensitivity spectrum summary (for example, negative sensitivity ratio, frequency of specific negative sensitivity classification, and ratio information), and simple frequencies (the current amount of frequency increase by times, and the amount of increase against a general frequency. If the user selects a detail view, monitoring information about more detailed risk states can be provided, and for this, the risk situation monitoring unit 116 may include the configuration illustrated in FIG. 8.

FIG. 8 is a detailed block diagram of the risk situation monitoring unit illustrated in FIG. 1. The risk situation monitoring unit may include a frequency monitoring block 802, a sensitivity spectrum monitoring block 804, a network distribution monitoring block 806, a media diffusion monitoring block 808, a similar case search block 810, and a risk feedback block 812. Referring to FIG. 8, the frequency monitoring block 802 may monitor and display on the screen current real-time frequencies and frequencies in the past social web content with respect to the risk entity through searching of the risk prediction quality DB 108 and the risk type DB 110.

Further, the sensitivity spectrum monitoring block 804 may provide sensitivity information about the risk entity as a spectrum with the passage of time, that is, information that has been sub-divided into positive and negative detailed sensitivity information (for example, anger, disappointment, or regret) together with the positive and negative information with the passage of time.

Next, the network distribution monitoring block 806 may define and provide a network propagation aspect in a graphic form or in a classification type of the propagation aspect so that a user can visually recognize the network propagation aspect in SNS content such as tweets. Here, the classification type may be any one of a distribution type, a compact type, and a diffusion type.

Further, the media diffusion monitoring block 808 may monitor a diffusion aspect of the social web content for the risk entity by media. That is, the media diffusion monitoring block 808 may provide information on the kind of medium in which the social web content for the risk entity is diffused (for example, news, blogs, tweets, or the like), and monitor and report the diffusion aspect, that is, the kind of medium in which the social web content first appeared before propagating to other media, such as tweet propagation after a news report, blog propagation after tweet diffusion, tweet propagation after block diffusion, or the like.

Further, the similar case search block 810 may search to determine whether there is a history in which a similar risk event has occurred in the risk entity that is currently monitored and in the past case through searching the risk prediction quality DB 108 and the risk type DB 110, and provide search result information to the user.

Last, the risk feedback block 812 may transfer feedback for a notification of the detected risk, which the system currently provides, to the system.

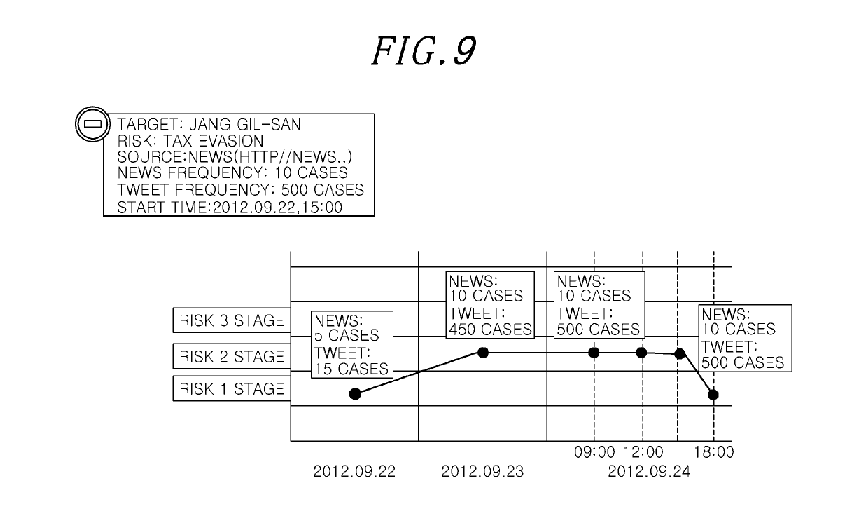

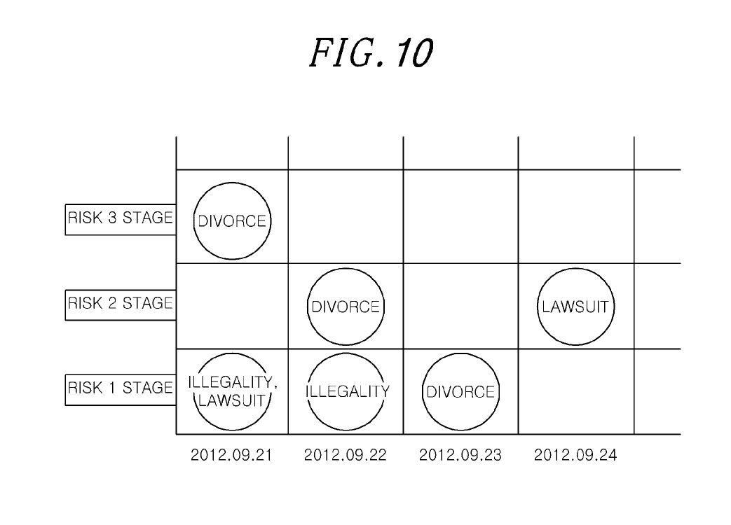

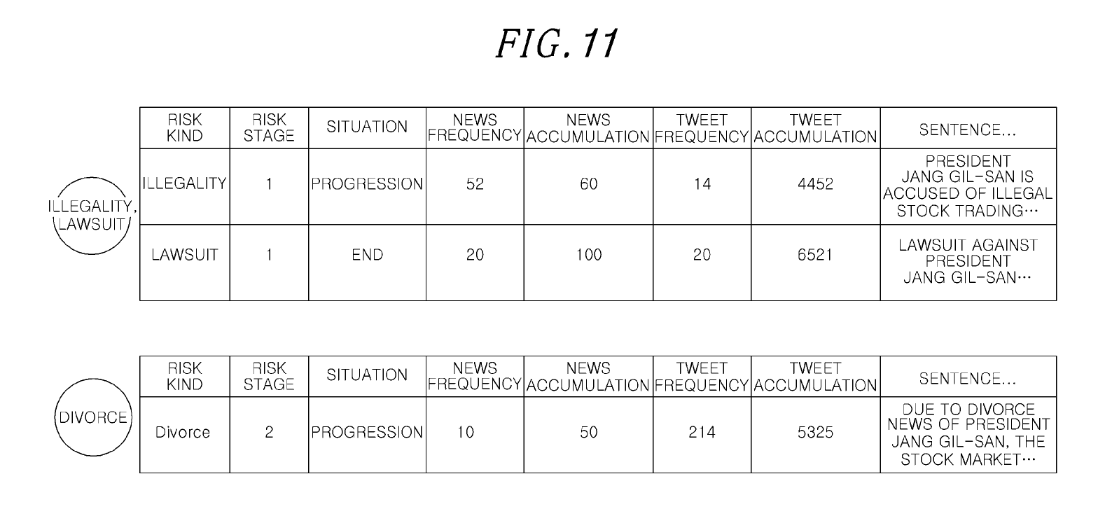

FIG. 9 is a conceptual view explaining an exemplary scenario 1 for monitoring detailed risk information in accordance with the present invention. FIG. 10 is a conceptual view explaining an exemplary scenario 2 for monitoring detailed risk information in accordance with the present invention. FIG. 11 is a conceptual view explaining an exemplary scenario 3 for monitoring detailed risk information in accordance with the present invention.

Referring to FIG. 9, a situation when the user selects a detailed content view with respect to one specific risk in the risk detection and notification scenario 2 illustrated in FIG. 5 is illustrated as a scenario, and monitoring of the risk stage information by date when the risk is detected, frequency information in news and tweets, and detailed information is provided.

Referring to FIG. 10, as an example of illustrating a scenario of a scene when the risk is searched for in a specific period, the monitoring result of the risk stage change by date and the detailed risk content with respect to the risk keyword that was searched for is provided.

Referring to FIG. 11, it is illustrated that more detailed information about the corresponding risk information is provided when the user selects a specific risk event (indicated by a circle, for example, divorce, illegality, a lawsuit, or the like) in FIG. 10.

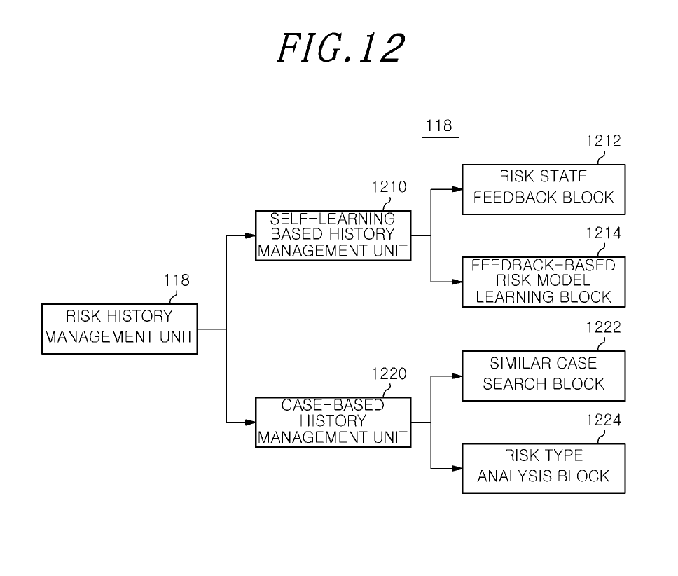

Referring again to FIG. 1, the risk history management unit 118 may receive user feedback for monitored risk information, and store and manage a record of a terminated risk situation in the risk history DB 112. For this, the risk history management unit 118 may include the configuration illustrated in FIG. 12.

FIG. 12 is a detailed block diagram of the risk history management unit illustrated in FIG. 1. The risk history management unit 118 may include a self-learning based history management unit 1210 that is composed of a risk state feedback block 1212 and a feedback-based risk model learning block 1214, and a case-based history management unit 1220 that is composed of a similar case search block 1222 and a risk type analysis block 1224.

Referring to FIG. 12, the risk state feedback block 1212 in the self-learning based history management unit 1210 may transfer feedback to a system with respect to a risk alarm that is provided from the system. That is, if the risk state feedback block 1212 transfers a risk release feedback in the case where the risk state that is currently provided by the system is not the risk state in accordance with the user's determination, the system reflects feedback information in the risk history management unit 118 in FIG. 1 for reflection in performance improvement.

Next, the feedback-based risk model learning block 1214 may re-learn a risk model in accordance with information reflected in the risk state feedback. That is, by re-learning the respective modeling of the prediction quality in accordance with the user's feedback information, the feedback-based risk model learning block 1214 may contribute to the performance improvement of the risk prediction.

Further, the similar case search block 1222 in the case-based history management unit 1220 may search to determine whether there is a history in which a similar risk event has occurred in the risk entity, which is currently monitored, and the past case through the search of the risk type DB 110 and the risk history DB 112, and may provide the search result information to the user. Here, the similar cases may provide searches for the risk events that occurred in the past with respect to the same risk entities, or cases (risk events) of similar risk events that occurred in the past with respect to the risk entities in the same classification as the risk entities (for example, similar product group, similar person, similar brand, and the like).

Further, the risk type analysis block 1224 may analyze the type of risk that is currently monitored and provide statistical information on the risk management entity. Here, the risk type may be provided as the risk event type (for example, boycott, nasty rumor, violation, or the like) in accordance with the risk entities, may be provided as a seasonal risk type or as a risk type that repeats over time, or may be classified as a one-time risk type or an ongoing risk type according to the aspect of diffusion. Such risk type information is stored in the risk type DB of FIG. 1.

The description of the present invention as described above is exemplary, and it will be understood by those of ordinary skill in the art to which the present invention pertains that various changes in form and detail may be made therein without changing the technical idea or essential features of the present invention. Accordingly, it will be understood that the above-described embodiments are exemplary in all aspects and do not limit the scope of the present invention.

Accordingly, the scope of the present invention is defined by the appended claims, and it will be understood that all corrections and modifications derived from the meanings and scope of the following claims and their equivalent concepts fall within the scope of the present invention.

What is claimed is:

1. An apparatus for managing a risk in a prediction-based manner on social web media, comprising:
a risk vocabulary management unit, which extracts and manages a vocabulary to be managed as pertaining to a risk from social web content;
a risk issue prediction analysis quality extraction unit, which extracts meta information related to a text that is an entity for analysis from an original of the social web content, and performs language analysis and sensitivity analysis;
a risk prediction modeling unit, which models risk prediction analysis through prediction of a statistical and mechanical learning method based on extracted qualities;
a risk detection and notification unit, which automatically detects the risk that is recognized based on risk prediction models pre-modeled from the social web content, and automatically notifies the detected risk;
a risk situation monitoring unit, which monitors in real time a risk state of a risk entity when an alarm is raised with respect to the detected risk; and
a risk history management unit, which receives user feedback for monitored risk information, and manages a record of a terminated risk situation.

2. The apparatus for managing a risk in a prediction-based manner of claim 1, wherein the vocabulary includes a keyword and an event to be managed as the risk.

3. The apparatus for managing a risk in a prediction-based manner of claim 2, wherein the risk vocabulary management unit comprises:
a manual input management block, which provides a user interface for inputting a risk entity keyword and an entity event to be managed;
a semi-automatic recommendation block, which provides a user input of specific social web content to be managed as the risk, and provides a user interface for registering the event and the keyword selected from the specific social web content; and
an automatic recommendation block, which automatically extracts the risk keyword and a risk event from similar pre-stored cases.

4. The apparatus for managing a risk in a prediction-based manner of claim 1, wherein the risk issue prediction analysis quality extraction unit comprises:
a social web content collection block, which collects and stores the social web content in real time;
a language analysis block, which analyzes a language through natural language processing with respect to the collected social web content;
a sensitivity analysis block, which analyzes sensitivity of each word based on sensitive words appearing in an input sentence;
a risk event quality extracting block, which extracts the risk event as any one quality of a noun form, a compound noun form, and a syntax form in accordance with a result of language analysis;
a frequency quality extracting block, which extracts information on how many times per unit time the risk entity keyword and the entity event appear in the social web content;
a sensitivity quality extracting block, which extracts sensitivity analysis information in a sentence with respect to the risk entity keyword, and extracts an extent to which a change of the corresponding sensitivity includes a negative sensitivity as a sensitivity quality;
a network propagation quality extracting block, which extracts a change of a propagation aspect of a network in a unit of time as a risk issue quality; and
a lifecycle quality extracting block, which extracts aspects of the risk keyword and the event appearing in the document as a lifecycle quality.

5. The apparatus for managing a risk in a prediction-based manner of claim 4, wherein the natural language processing includes preprocessing of the social web content, morphological analysis, named entity recognition, syntax analysis, and relation extraction.

6. The apparatus for managing a risk in a prediction-based manner of claim 5, wherein the natural language processing is differently applied depending on a kind and a stage of prediction quality for the social web content.

7. The apparatus for managing a risk in a prediction-based manner of claim 4, wherein the sensitivity analysis block extracts and subdivides degrees of sensitivity of the respective words as numerical information.

8. The apparatus for managing a risk in a prediction-based manner of claim 4, wherein the sensitivity analysis block classifies the sensitivity of each word into any one of “positive”, “negative”, “neutral”, and “quality”.

9. The apparatus for managing a risk in a prediction-based manner of claim 4, wherein the frequency quality extracting block extracts whether extraction occurs at a relatively high frequency in a relatively short time, whether continuity is maintained, or whether an abnormal frequency that is different from a normal frequency is extracted, through modeling of frequencies over time, as a frequency quality.

10. The apparatus for managing a risk in a prediction-based manner of claim 4, wherein the network propagation quality extracting block extracts whether a form of the network propagation aspect is uniformly distributed to other user groups and whether a propagation speed is high as a network propagation quality.

11. The apparatus for managing a risk in a prediction-based manner of claim 4, wherein the lifecycle quality extracting block classifies and defines frequencies by time periods into lifecycle forms and types of “new”, “dead”, and “recycled” to utilize the frequencies as modeling qualities for indicating whether the aspect is a normal phenomenon or a phenomenon that can be recognized as a risk state.

12. The apparatus for managing a risk in a prediction-based manner of claim 1, wherein the risk prediction modeling unit uses any one of logistic regression, linear regression, and an SVM method as the statistical and mechanical method.

13. The apparatus for managing a risk in a prediction-based manner of claim 1, wherein the risk situation monitoring unit comprises:
a frequency monitoring block monitoring frequencies in current real-time frequencies and frequencies in the past social web content with respect to the risk entity;
a sensitivity spectrum monitoring block providing sensitivity information of the risk entity as a spectrum over time;
a network distribution monitoring block defining and providing a network propagation aspect in a graphic form or in a classification type of the propagation aspect;
a media diffusion monitoring block monitoring a diffusion aspect of the social web content for the risk entity by medium;
a similar case search block searching whether there is a history in which a similar risk event has occurred in the risk entity and a past case; and
a risk feedback block transferring feedback for an alarm of the detected risk.

14. The apparatus for managing a risk in a prediction-based manner of claim 13, wherein the classification type is any one of a distribution type, a compact type, and a diffusion type.

15. The apparatus for managing a risk in a prediction-based manner of claim 1, wherein the risk history management unit comprises:
a risk state feedback block transferring feedback to a system with respect to a risk alarm;
a feedback-based risk model learning block re-learning a risk model in accordance with information reflected in the risk state feedback;
a similar case search block searching to determine whether there is a history in which a similar risk event has occurred in the risk entity and the past cases; and
a risk type analysis block analyzing a type of the risk and providing statistical information on the risk management entity.

16. The apparatus for managing a risk in a prediction-based manner of claim 15, wherein the risk state feedback block transfers a risk release feedback to the system for reflection of performance improvement in the case where a risk state is not present.

17. The apparatus for managing a risk in a prediction-based manner of claim 15, wherein the similar case search block searches for a risk event occurring in the past in the same risk entity or a similar risk event occurring in the past in a risk entity of the same classification.

18. The apparatus for managing a risk in a prediction-based manner of claim 15, wherein the risk type analysis block provides any one of a risk event type according to the risk entity, a seasonal risk type or a risk type that is repeated over time, and a one-time risk type or an ongoing risk type according to the aspect of diffusion.

19. A method for managing a risk in a prediction-based manner on social web media, comprising:
extracting and managing a vocabulary to be managed as pertaining to a risk from social web content;
extracting meta information related to a text that is an entity for analysis from social web content, and performing language analysis and sensitivity analysis;
modeling risk prediction analysis through prediction of a statistical and mechanical learning method based on extracted qualities;
automatically detecting and notifying the risk that is recognized based on risk prediction models pre-modeled from the social web content;
monitoring in real time a risk state of a risk entity when an alarm is raised with respect to the detected risk; and
recording a related risk termination situation in a risk history DB when the situation of the detected risk is terminated.

20. The method for managing a risk in a prediction-based manner of claim 19, wherein the modeling uses any one of logistic regression, linear regression, and an SVM method as the statistical and mechanical method.
